(19) United States
(12) Patent Application Publication
(10) Pub. No.: US 2023/0020064 A1
(43) Pub. Date: Jan. 19, 2023

(54) CIRCULATING AQUACULTURE FACILITY FOR SALTWATER PONDS

(71) Applicant: Zhejiang Wanli University, Ningbo (CN)

(72) Inventor: Lin He, Ningbo (CN)

(21) Appl. No.: 17/474,083

(22) Filed: Sep. 14, 2021

(30) Foreign Application Priority Data
Jul. 13, 2021 (CN) 202110789112.X

(51) Int. Cl. A01K 63/00; A01K 63/04

(52) U.S. Cl. CPC A01K 63/006; A01K 63/042; A01K 63/045; A01K 63/047; A01K 61/59

(57) ABSTRACT

Provided is a circulating aquaculture facility for saltwater ponds. The circulating aquaculture facility comprises a cultivation tank, a division plate vertically arranged in the cultivation tank to divide an inner cavity of the cultivation tank into a left inner chamber and a right inner chamber; a water inlet pipeline, water in the water inlet pipeline enters the cultivation tank through the left rectangular through hole of the cultivation tank; an outlet pipeline, sewage discharged from the right rectangular through hole of the cultivation tank is capable of entering the outlet pipeline; and an oxygen supply device which delivers oxygen to the inner bottom of the cultivation tank.

### CROSS REFERENCE OF RELATED APPLICATIONS

The present disclosure claims the benefit of Chinese Patent Application No. 202110789112.X entitled “CIRCULATING AQUACULTURE FACILITY FOR SALTWATER PONDS,” filed on Jul. 13, 2021, in the China National Intellectual Property Administration, the entire content of which is incorporated herein in its entirety.

### TECHNICAL FIELD

The present disclosure relates to the technical field of aquaculture in saltwater ponds, in particular to a circulating aquaculture facility for saltwater ponds.

### BACKGROUND

The circulating culture technology for saltwater ponds can make full use of aquaculture feed, and has the advantages of reducing the cost of aquaculture. Circulating aquaculture in saltwater ponds is realized by circulating aquaculture facilities. When the circulating aquaculture facilities are used for fish and shrimp co-cultivation, the feed is spread into the cultivation tank, which can effectively prevent the waste of feed. In addition, the oxygen supply device through circulating breeding can provide sufficient oxygen for the fish and shrimp raised in the cultivation tank, which can effectively ensure the metabolism of the fish and shrimp. However, the existing circulating cultivation facilities have the following two shortcomings, one is that fish and shrimp cannot be cultured separately, which leads to the inability to supply feeds of different ingredients reasonably on demand, and the other is that it is not convenient to clean up fish and shrimp excrement.

### SUMMARY

The purpose of the present disclosure is to provide a circulating aquaculture facility for saltwater ponds, aiming to improve the existing circulating aquaculture facilities that fails separate fish and shrimp in different environments, and clean up fish and shrimp excrement properly.

The present disclosure is achieved by the circulating aquaculture facility for saltwater ponds comprising the follows:
a cultivation tank, wherein the cultivation tank is cuboid-shaped; an upper end of the cultivation tank is opened; a lower end of a left wall of the cultivation tank is provided with a left rectangular through hole; a lower end of a right wall of the cultivation tank is provided with a right rectangular through hole; the right rectangle through hole is provided with a second filter screen therein;
a division plate vertically arranged in the cultivation tank to divide an inner cavity of the cultivation tank into a left inner chamber and a right inner chamber; a gap is defined between a lower end of the division plate and an inner bottom of the cultivation tank; a first filter screen is arranged in the gap;
a water inlet pipeline, wherein a water inlet end of the water inlet pipeline is connected to a water inlet pump; a water outlet end is connected to the left rectangular through hole of the cultivation tank; water in the water inlet pipeline enters the cultivation tank through the left rectangular through hole of the cultivation tank;
an outlet pipeline, wherein an inlet end of the outlet pipeline is connected to the right rectangular through hole of the cultivation tank; an outlet end is connected to an outlet pump, so that sewage discharged from the right rectangular through hole of the cultivation tank is capable of entering the outlet pipeline; and
an oxygen supply device which delivers oxygen to the inner bottom of the cultivation tank.

In some embodiments, the water inlet pipeline comprises a rectangular water inlet pipe, a circular water inlet pipe, and a rectangular box; the rectangular water inlet pipe is L-shaped, with one end being connected to the left rectangular through hole on the left wall of the cultivation tank, and the other to a bottom wall of the rectangular box; a through hole is provided on the bottom wall of the rectangular box to in connection with the rectangular water inlet pipe; a water inlet end of the circular water inlet pipe is connected to a water inlet pump; the circulate water inlet pipe allows the water to be delivered to the rectangular box.

In some embodiments, an upper end surface of the rectangular box is evenly provided with a plurality of water inlet through holes along a length direction of the upper end surface of the rectangular box; each water inlet through hole is connected to a water distribution pipe, and each water distribution pipe is connected to a circular water inlet pipe.

In some embodiments, the water outlet pipeline comprises a rectangular water outlet pipe and a circular water outlet pipe, with one end of the rectangular water outlet pipe being connected to the right rectangular through hole on the right wall of the cultivation tank, and the other to the circular water outlet pipe; the circular water outlet pipe is connected to a water outlet pump.

In some embodiments, an upper wall of the rectangular water outlet pipe is evenly provided with a plurality of air pipe joints along a length direction of the upper wall of the rectangular water outlet pipe; each air pipe joint is connected to a recoil air pipe; a first one-way valve is arranged between the recoil air pipe and the air pipe joint; each recoil air pipe is connected to a pressure source.

In some embodiments, a right end of the right inner chamber of the cultivation tank is vertically provided with a baffle; the baffle is vertically arranged and the length direction of the baffle is along a direction from front to rear of the cultivation tank; an upper end of the baffle is provided with a connecting rod; the connecting rod is vertically arranged; an upper right end of the cultivation tank is provided with a mounting frame; the mounting frame is provided with a driving cylinder; a lower end of a piston rod of the diving cylinder is connected to an upper end of the connecting rod.

In some embodiments, the upper end of the baffle is provided with a guide rod on each of the front and rear sides of the connecting rod; the guide rod is arranged vertically, and an inner wall of the right wall of the cultivation tank is provided with two guide plates; each guide plate is provided with a guide through hole, and the two guide rods respectively pass through the guide through hole of the guide plate.

In some embodiments, the oxygen supply device comprises an oxygen generator and an oxygen delivery pipe; one end of the oxygen delivery pipe is connected to an oxygen outlet of the oxygen generator, and the other end is connected to a circular water inlet pipe; the oxygen delivery pipe is provided with an oxygen delivery valve.

In some embodiments, the oxygen supply device comprises an oxygen generator and an oxygen delivery pipeline; the oxygen delivery pipeline comprises a vertical pipe, a transverse pipe and a plurality of connecting short pipes; a length direction of the transverse pipe is defined from left to right of the cultivation tank; both ends of the transverse pipe are sealed; the plurality of connecting short pipes are provided between the transverse pipe and a front wall or rear wall of the cultivation tank for connecting the transverse pipe and the front wall or rear wall of the cultivation tank; each connecting short pipe is uniformly arranged along a direction of the horizontal pipe; a second one-way valve is arranged on each of the connecting short pipes; a lower end of the vertical pipe is connected to an upper wall of the transverse pipe; an upper end of the vertical pipe is connected to the oxygen outlet of the oxygen generator.

In some embodiments, two oxygen delivery pipelines are provided; the two oxygen delivery pipelines are respectively arranged on the front a rear sides of the cultivation tank; the two transverse pipes of the two oxygen delivery pipelines are respectively located at the front side of the cultivation tank and the rear side of the cultivation tank; the horizontal pipe located on the front side of the cultivation tank is connected to the lower end of the front wall of the cultivation tank through the plurality of connecting short pipes; the transverse pipe located on the rear side of the cultivation tank is connected to the lower end of the rear wall of the cultivation tank through the plurality of connecting short pipes.

Compared with the prior art, the beneficial effects of the present disclosure are as follows.
1. The present disclosure can separate fish and shrimp in different cultivation environments, making the cultivation more efficient. The present disclosure can also transport the uneaten fish feed to the shrimp for consumption, making the cultivation feed fully utilized, reducing the cultivation cost and, moreover, providing convenience for excrement cleaning.
2. The present disclosure comprises a reoil air pipe, which can be fed with compressed air. The compressed air of the recoil air pipe first enters the rectangular water outlet pipe, and then enters the right rectangular through hole of the cultivation tank. The air pressure impact of the second filter screen can effectively prevent the occurrence of clogging accidents of the second filter screen, and can effectively ensure the discharge of fish and shrimp excrement.
3. The right end of the right inner chamber of the cultivation tank is vertically provided with a baffle, and the upper right end of the cultivation tank is provided with a driving cylinder. The driving cylinder can drive the baffle to move up and down through the connecting rod. Before compressed air is applied to the second filter screen, the baffle is first driven to move downward by the driving cylinder, so that the lower end of the baffle is connected to the inner bottom wall of the cultivation tank, and then the second filter screen is subjected to compressed air, effectively reducing the impact range of air pressure shock, reducing the impact to the environment of the right inner chamber of the cultivation tank caused by fish and shrimp excrement.

### BRIEF DESCRIPTION OF THE DRAWINGS

In order to explain the technical solutions of the embodiments of the present invention more clearly, the following will briefly introduce the drawings that need to be used in the embodiments. It should be understood that the following drawings only show certain embodiments of the present invention, and therefore do not It should be regarded as a limitation of the scope. For those of ordinary skill in the art, without creative work, other related drawings can be obtained based on these drawings.

FIG. 1 is a schematic diagram of the aquaculture facility according to the first embodiment of the present disclosure.

FIG. 2 is a right-top perspective view of the aquaculture facility without the oxygen supply device according to the first embodiment of the present disclosure.

FIG. 3 is a left-top perspective view of the aquaculture facility without the oxygen supply device according to the first embodiment of the present disclosure.

FIG. 4 is a schematic diagram of the aquaculture facility according to the second embodiment of the present disclosure.

FIG. 5 is a top view of the aquaculture facility without the oxygen supply device according to the second embodiment of the present disclosure.

FIG. 6 is a cross-sectional diagram of the cultivation tank and the division plate according to the present disclosure.

FIG. 7 is a perspective schematic of the baffle and the driving device.

In the drawings: 1-cultivation tank; 2-division plate; 3-rectangular water inlet pipe; 4-circular water inlet pipe; 5-rectangular box; 6-water distribution pipe; 7-rectangular water outlet pipe; 8-circular water outlet pipe; 9-recoil air pipe; 10-first one-way valve; 11-oxygen generator; 12-oxygen delivery pipe; 13-oxygen delivery valve; 14-vertical pipe; 15-horizontal pipe; 16-connecting short pipe; 17-second one-way valve; 19-mounting frame; 20-driving cylinder; 21-baffle; 22-connecting rod; 23-guide rod; 24-guirde plate; 25-first filter screen; 26-second filter screen.

### DETAILED DESCRIPTION OF THE EMBODIMENTS

In order to make the objectives, technical solutions, and advantages of the embodiments of the present invention clearer, the technical solutions in the embodiments of the present invention will be described clearly and completely in conjunction with the accompanying drawings in the embodiments of the present invention. Obviously, the described embodiments It is a part of the embodiments of the present invention, but not all of the embodiments. Therefore, the following detailed description of the embodiments of the present invention provided in the accompanying drawings is not intended to limit the scope of the claimed invention, but merely represents selected embodiments of the present invention. Based on the embodiments of the present invention, all other embodiments obtained by those of ordinary skill in the art without creative work shall fall within the protection scope of the present invention.

### First Embodiment

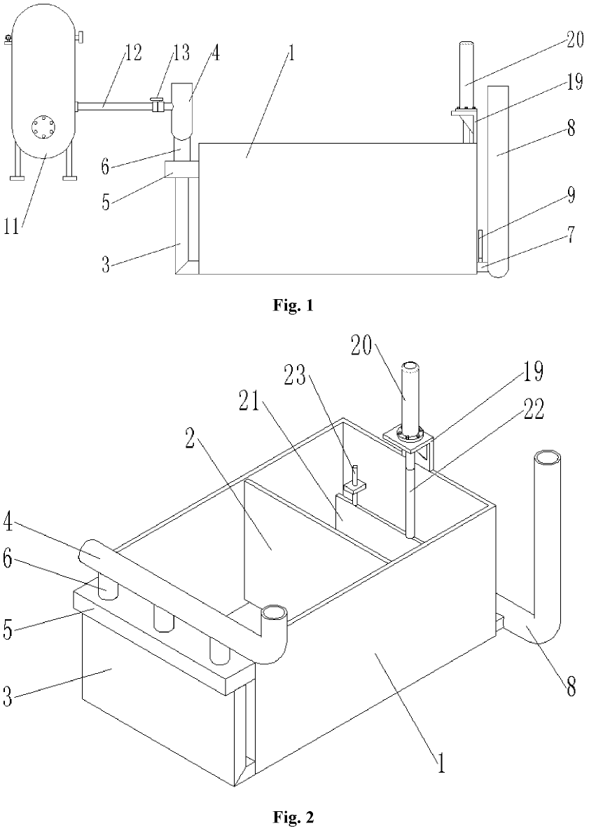

A circulating aquaculture facility for saltwater ponds is provided, referring to FIG. 1 to FIG. 3. The circulating aquaculture facility comprises a cultivation tank 1, a division plate 2, a rectangular water inlet pipe 3, a circular water inlet pipe 4, a rectangular box 5, a distribution pipe 6, a rectangular water outlet pipe 7, a circular water outlet pipe 8 and an oxygen generator 11. The cultivation tank 1 is rectangular-shaped with its upper end opened. A lower end of a left wall of the cultivation tank 1 is provided with a left rectangular through hole. A lower end of a right wall of the cultivation tank 1 is provided with a right rectangular through hole. The division plate 2 is vertically arranged in the cultivation tank 1 to divide an inner cavity of the cultivation tank 1 into a left inner chamber and a right inner chamber. The left inner chamber is used for fish cultivation, and the right inner chamber is used for shrimp cultivation. A gap is defined between a lower end of the division plate 2 and an inner bottom wall of the cultivation tank 1.

The rectangular water inlet 3 is L-shaped, one end of which is connected to the left rectangular through hole on the left wall of the cultivation tank 1, and the other to the bottom wall of the rectangular box 5. The bottom wall of the rectangular box 5 is provided with through holes in connection with the rectangular water inlet pipe 3. The left rectangular through hole of the cultivation tank 1 is in communication with the through hole on the bottom wall of the rectangular box 5 via the rectangular water inlet pipe 3. The upper end surface of the rectangular box 5 is uniformly provided with a plurality of water inlet through holes along its length, and each water inlet through hole is connected to a water distribution pipe 6. Each water distribution pipe 6 is connected to the circular water inlet pipe 4. The water inlet end of the circular water inlet pipe 4 is connected to a water inlet pump. The water pumped by the water inlet pump enters the circular water inlet pipe 4 first, and then enters the rectangular box 5 through each water distribution pipe 6. The arrangement of the water distribution pipes 6 can make the water in the circular water inlet pipe 4 evenly enter the rectangular box 5. The water in the rectangular tank 5 enters the cultivating tank 1 through the L-shaped rectangular water inlet pipe 3 and the left rectangular through hole of the cultivation tank 1. Under the action of the water delivered by the water inlet pump, the uneaten feed and fish excrement of the fish at the bottom of the left inner chamber of the cultivation tank 1 enter the right inner chamber through the gap located between the lower end of the division plate 2 and the inner bottom wall of the cultivation tank 1 for feeding the shrimp. This allows the aquaculture feed to be more fully utilized, and the cultivation cost can be reduced.

One end of the rectangular water outlet pipe 7 is connected to the right rectangular through hole on the right wall of the cultivation tank 1, while the other end to the circular water outlet pipe 8. The circular water outlet pipe 8 is connected to the water outlet pump. Initiating the water outlet pump, and the water in the right inner chamber of the cultivation tank 1 enters the rectangular water outlet pipe 7 first, and then enters the water outlet pump through the circular water outlet pipe 8. At last, the water will be discharged from the sewage pipe connected to the outlet end of the water outlet pump. Under the action of the water outlet pump, the rectangular water outlet pipe 7 and the circular water outlet pipe 8, the excrement of the fish and shrimp on the bottom of the right inner chamber of the cultivation tank 1 will be discharged from the cultivation tank 1, and this will improve the cultivation environment of the cultivation tank 1.

Referring to FIG. 6, a first filter screen 25 is provided in the gap between the lower end of the division plate 2 and the inner bottom wall of the cultivation tank 1. A second filter screen 26 is provided in the right rectangular through hole. The filter size of the first filter screen 25 and the second filter screen 26 may be such configured that the shrimp in the right inner chamber will not enter the left inner chamber of the cultivation tank 1 and will not be sucked and discharged by the water outlet pump.

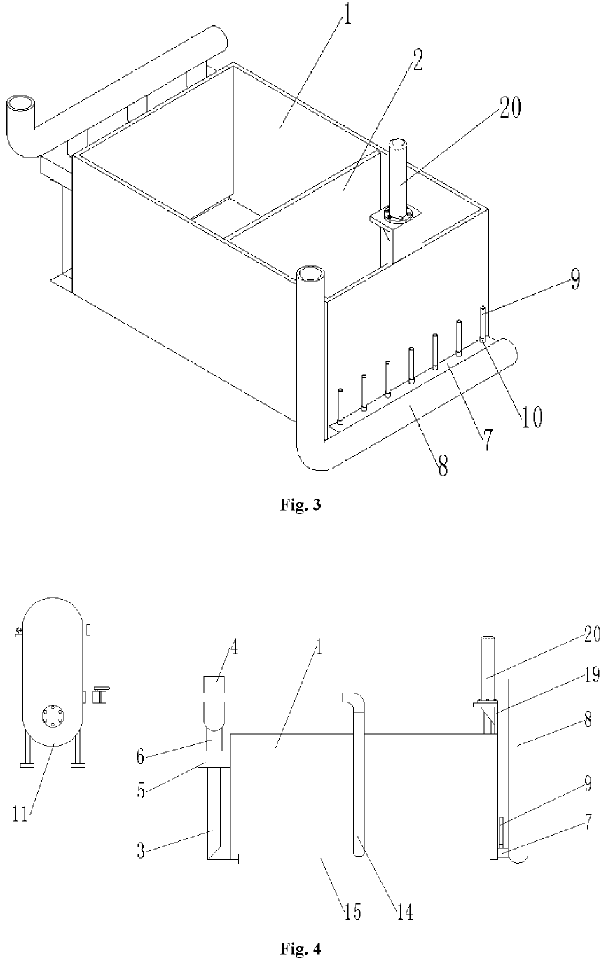

Please referring to FIG. 3, the upper wall of the rectangular water outlet pipe 7 is evenly provided with a plurality of air pipe joints along its length. Each air pipe joint is connected to a recoil air pipe 9, and each recoil air pipe 9 is connected to a compressed air tank or an air pipe. The compressor is connected, and the compressed air tank or air compressor inputs compressed air into the recoil air pipe 9. The compressed air first enters the rectangular water outlet pipe 7, and then enters the right rectangular through hole of the breeding tank 1, opposite to the right rectangular through hole. The second filter screen 26 performs air pressure impact, which can effectively prevent the occurrence of clogging accidents of the second filter screen 26, and can effectively ensure the discharge of fish and shrimp excrement. In order to prevent the pollution of the aquaculture water by compressed air, the compressed air must undergo degreasing treatment before it enters the recoil pipe 9. A first one-way valve 10 is arranged between the recoil air pipe 9 and the air pipe joint, and the first one-way valve 10 can prevent fish and shrimp excrement from entering the recoil air pipe 9.

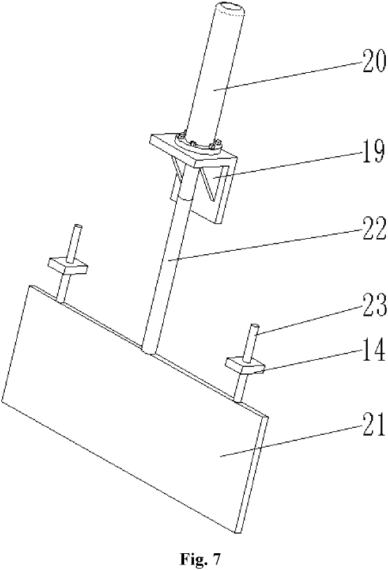

Referring to FIG. 2 and FIG. 7, the right end of the right inner chamber of the cultivation tank 1 is vertically provided with a baffle 21. The baffle 21 is vertically arranged and its length is along the front and rear direction of the cultivation tank 1. The upper end of the baffle 21 is fixedly provided with a connecting rod 22. The connecting rod 22 is vertically arranged. A guide rod 23 is provided on the upper end of the baffle 21 at the front and rear sides of the connecting rod 22. The guide rod 23 is also vertically arranged. Two guide plates 24 are provided on the inner side wall of the right wall of the cultivation tank 1. A guide through hole is provided on each of the two guide plates 24. The two guide rods 23 are respectively passed through the guide through holes of a guide plate 24. A mounting frame 19 is provided on the upper right side of the breeding tank 1, and a driving cylinder 20 is provided on the mounting frame 19. The lower end of the piston rod of the driving cylinder 20 is connected with the upper end of the connecting rod 22. The driving cylinder 20 can be an air cylinder or an electric cylinder, and the driving cylinder 20 drives the baffle 21 to move up and down through the connecting rod 22. Before the second filter screen 26 is impacted by compressed air, the baffle 21 is driven downward by the driving cylinder 20, so that the lower end of the baffle 21 is connected to the inner bottom wall of the breeding tank 1, and then the second filter screen 26 is air pressure shocked by the compressed air. This can effectively reduce the influence range of air pressure shock and reduce the impact of the fish and shrimp excrement driven by the air pressure shock on the cultivation environment of the right inner chamber of the cultivation tank 1.

Referring to FIG. 1, the oxygen supply device includes an oxygen generator 11 and an oxygen pipe 12. One end of the oxygen pipe 12 is connected to the oxygen outlet of the oxygen generator 11, and the other end is connected to the circular water inlet pipe 4. The oxygen pipe 12 is provided with an oxygen valve 13. The oxygen produced by the oxygen generator 11 first enters the circular water inlet pipe 4 through the oxygen pipe 12. The oxygen then is mixed with the water in the circular water inlet pipe 4, and then enters the inner bottom of the cultivation tank 1 along with the water flow. Accordingly, the oxygen supply device can provide sufficient oxygen to the fish and shrimp raised in the cultivation tank 1 and provide oxygen guarantee for the normal growth of the fish and shrimp.

The working principle of the present invention: the present invention can divide the inner cavity of the cultivation tank 1 into a left inner chamber and a right inner chamber by providing the division plate 2. The left inner chamber is used for fish cultivation, and the right inner chamber is used for shrimp cultivation. The fish and shrimp can be cultivated separately, which facilitates the reasonable supply of feeds of different ingredients on demand, and makes the cultivation more efficient. The invention can pass the uneaten fish feed and fish excrement at the bottom of the left inner chamber of the cultivation tank 1 to the right inner chamber of the cultivation tank 1 for the shrimp, through the gap between the lower end of the division plate 2 and the inner bottom wall of the cultivation tank 1, under the action of the water delivered by the external water inlet pump. This can increase the utilization of the cultivation feed and reduce the cultivation cost. The excrement of fish and shrimp at the bottom of the right inner chamber of the cultivation tank 1 can be discharged from the cultivation tank 1 under the action of an external water outlet pump, which effectively improves the cultivation environment in the cultivation tank 1.

Accordingly, the present invention can separate fish and shrimp in different cultivation environment, making the cultivation more efficient. Furthermore, the present invention can transport the uneaten fish feed from the fish chamber to the shrimp for consumption, so that the aquaculture feed can be more fully utilized, and the breeding cost is reduced. The cultivation cost is therefore reduced.

### Second Embodiment

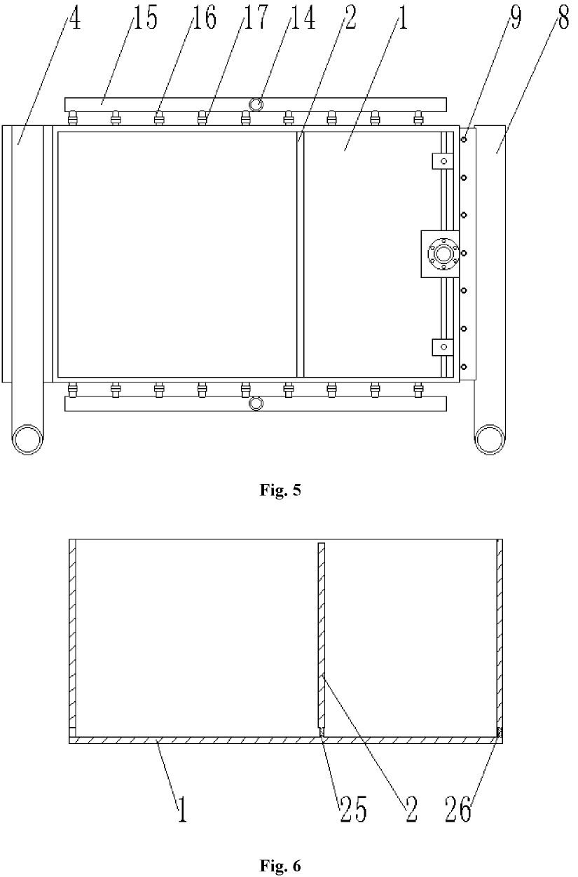

A circulating aquaculture facility for saltwater ponds is provided, referring to FIG. 4 to FIG. 5. The circulating aquaculture facility comprises a cultivation tank 1, a division plate 2, a rectangular water inlet pipe 3, a circular water inlet pipe 4, a rectangular box 5, a distribution pipe 6, a rectangular water outlet pipe 7, a circular water outlet pipe 8 and an oxygen generator 11. The cultivation tank 1 is rectangular-shaped with its upper end opened. A lower end of a left wall of the cultivation tank 1 is provided with a left rectangular through hole. A lower end of a right wall of the cultivation tank 1 is provided with a right rectangular through hole. The division plate 2 is vertically arranged in the cultivation tank 1 to divide an inner cavity of the cultivation tank 1 into a left inner chamber and a right inner chamber. The left inner chamber is used for fish cultivation, and the right inner chamber is used for shrimp cultivation. A gap is defined between a lower end of the division plate 2 and an inner bottom wall of the cultivation tank 1.

The rectangular water inlet 3 is L-shaped, one end of which is connected to the left rectangular through hole on the left wall of the cultivation tank 1, and the other to the bottom wall of the rectangular box 5. The bottom wall of the rectangular box 5 is provided with through holes in connection with the rectangular water inlet pipe 3. The left rectangular through hole of the cultivation tank 1 is in communication with the through hole on the bottom wall of the rectangular box 5 via the rectangular water inlet pipe 3. The upper end surface of the rectangular box 5 is uniformly provided with a plurality of water inlet through holes along its length, and each water inlet through hole is connected to a water distribution pipe 6. Each water distribution pipe 6 is connected to the circular water inlet pipe 4. The water inlet end of the circular water inlet pipe 4 is connected to a water inlet pump. The water pumped by the water inlet pump enters the circular water inlet pipe 4 first, and then enters the rectangular box 5 through each water distribution pipe 6. The arrangement of the water distribution pipes 6 can make the water in the circular water inlet pipe 4 evenly enter the rectangular box 5. The water in the rectangular tank 5 enters the cultivating tank 1 through the L-shaped rectangular water inlet pipe 3 and the left rectangular through hole of the cultivation tank 1. Under the action of the water delivered by the water inlet pump, the uneaten feed and fish excrement of the fish at the bottom of the left inner chamber of the cultivation tank 1 enter the right inner chamber through the gap located between the lower end of the division plate 2 and the inner bottom wall of the cultivation tank 1 for feeding the shrimp. This allows the aquaculture feed to be more fully utilized, and the cultivation cost can be reduced.

One end of the rectangular water outlet pipe 7 is connected to the right rectangular through hole on the right wall of the cultivation tank 1, while the other end to the circular water outlet pipe 8. The circular water outlet pipe 8 is connected to the water outlet pump. Initiating the water outlet pump, and the water in the right inner chamber of the cultivation tank 1 enters the rectangular water outlet pipe 7 first, and then enters the water outlet pump through the circular water outlet pipe 8. At last, the water will be discharged from the sewage pipe connected to the outlet end of the water outlet pump. Under the action of the water outlet pump, the rectangular water outlet pipe 7 and the circular water outlet pipe 8, the excrement of the fish and shrimp on the bottom of the right inner chamber of the cultivation tank 1 will be discharged from the cultivation tank 1, and this will improve the cultivation environment of the cultivation tank 1.

Referring to FIG. 6, a first filter screen 25 is provided in the gap between the lower end of the division plate 2 and the inner bottom wall of the cultivation tank 1. A second filter screen 26 is provided in the right rectangular through hole. The filter size of the first filter screen 25 and the second filter screen 26 may be such configured that the shrimp in the right inner chamber will not enter the left inner chamber of the cultivation tank 1 and will not be sucked and discharged by the water outlet pump.

Please referring to FIG. 4 and FIG. 5, the upper wall of the rectangular water outlet pipe 7 is evenly provided with a plurality of air pipe joints along its length. Each air pipe joint is connected to a recoil air pipe 9, and each recoil air pipe 9 is connected to a compressed air tank or an air pipe. The compressor is connected, and the compressed air tank or air compressor inputs compressed air into the recoil air pipe 9. The compressed air first enters the rectangular water outlet pipe 7, and then enters the right rectangular through hole of the breeding tank 1, opposite to the right rectangular through hole. The second filter screen 26 performs air pressure impact, which can effectively prevent the occurrence of clogging accidents of the second filter screen 26, and can effectively ensure the discharge of fish and shrimp excrement. In order to prevent the pollution of the aquaculture water by compressed air, the compressed air must undergo degreasing treatment before it enters the recoil pipe 9. A first one-way valve 10 is arranged between the recoil air pipe 9 and the air pipe joint, and the first one-way valve 10 can prevent fish and shrimp excrement from entering the recoil air pipe 9.

Referring to FIG. 5 and FIG. 7, the right end of the right inner chamber of the cultivation tank 1 is vertically provided with a baffle 21. The baffle 21 is vertically arranged and its length is along the front and rear direction of the cultivation tank 1. The upper end of the baffle 21 is fixedly provided with a connecting rod 22. The connecting rod 22 is vertically arranged. A guide rod 23 is provided on the upper end of the baffle 21 at the front and rear sides of the connecting rod 22. The guide rod 23 is also vertically arranged. Two guide plates 24 are provided on the inner side wall of the right wall of the cultivation tank 1. A guide through hole is provided on each of the two guide plates 24. The two guide rods 23 are respectively passed through the guide through holes of a guide plate 24. A mounting frame 19 is provided on the upper right side of the breeding tank 1, and a driving cylinder 20 is provided on the mounting frame 19. The lower end of the piston rod of the driving cylinder 20 is connected with the upper end of the connecting rod 22. The driving cylinder 20 can be an air cylinder or an electric cylinder, and the driving cylinder 20 drives the baffle 21 to move up and down through the connecting rod 22. Before the second filter screen 26 is impacted by compressed air, the baffle 21 is driven downward by the driving cylinder 20, so that the lower end of the baffle 21 is connected to the inner bottom wall of the breeding tank 1, and then the second filter screen 26 is air pressure shocked by the compressed air. This can effectively reduce the influence range of air pressure shock and reduce the impact of the fish and shrimp excrement driven by the air pressure shock on the cultivation environment of the right inner chamber of the cultivation tank 1.

Referring to FIGS. 4 and 5, the oxygen supply device includes an oxygen generator 11 and an oxygen pipeline. There are two oxygen pipelines, and each oxygen pipelines includes a vertical pipe 14, a transverse pipe 15 and a plurality of connecting short pipes 16. The two oxygen pipelines are respectively arranged on the front and rear sides of the cultivation tank 1. The two transverse pipes 15 of the two oxygen pipelines are respectively located on the front side of the cultivation tank 1 and the rear side of the cultivation tank 1. The transverse pipe 15 that located at the front side of the cultivation tank 1 is connected to the lower end of the front wall of the culturing tank 1 through a plurality of connecting short pipes 16. These connecting short pipes 16 are uniformly arranged along the length direction of the transverse pipe 15 on the front side of the cultivation tank 1. The transverse pipe 15 located on the rear side of the cultivation tank 1 is connected to the lower end of the rear wall of the cultivation tank 1 through a plurality of connecting short pipes 16. These connecting short pipes 16 are evenly arranged along the length direction of the transverse pipe 15 on the rear side of the cultivation tank 1. In order to prevent fish and shrimp and the excrement of fish and shrimp from entering the transverse pipe 15, a second one-way valve 17 is installed on each connecting short pipe 16. The lower end of the vertical pipe 14 is connected with the upper end wall of the transverse pipe 15, and the upper end is connected with the oxygen outlet of the oxygen generator 11. The oxygen produced by the oxygen generator 11 first enters the vertical pipe 14, and then enters the transverse pipe 15, and finally enters the inner bottom of the cultivation tank 1 evenly through the connecting short pipes 16, so as to provide sufficient fish and shrimps in the cultivation tank 1. The oxygen provides oxygen guarantee for the normal growth of fish and shrimp.

Compared with the oxygen supply device in the first embodiment, the oxygen supply device in this embodiment has a more complicated structure and higher cost, but it has the advantage of more uniform oxygen supply. Moreover, it can be used when fish and shrimp excrement is not cleaned, and the use is more flexible, saving the cultivation cost.

The above are only the preferred embodiments of the present invention and are not used to limit the present invention. For those skilled in the art, the present invention can have various modifications and changes. Any modification, equivalent replacement, improvement, etc. made within the spirit and principle of the present invention shall be included in the protection scope of the present invention.

What is claimed is:

1. A circulating aquaculture facility for saltwater ponds, comprising:
a cultivation tank, wherein the cultivation tank is cuboid-shaped; an upper end of the cultivation tank is opened; a lower end of a left wall of the cultivation tank is provided with a left rectangular through hole; a lower end of a right wall of the cultivation tank is provided with a right rectangular through hole; the right rectangle through hole is provided with a second filter screen therein;
a division plate vertically arranged in the cultivation tank to divide an inner cavity of the cultivation tank into a left inner chamber and a right inner chamber; a gap is defined between a lower end of the division plate and an inner bottom of the cultivation tank; a first filter screen is arranged in the gap;
a water inlet pipeline, wherein a water inlet end of the water inlet pipeline is connected to a water inlet pump; a water outlet end is connected to the left rectangular through hole of the cultivation tank; water in the water inlet pipeline enters the cultivation tank through the left rectangular through hole of the cultivation tank;
an outlet pipeline, wherein an inlet end of the outlet pipeline is connected to the right rectangular through hole of the cultivation tank; an outlet end is connected to an outlet pump, so that sewage discharged from the right rectangular through hole of the cultivation tank is capable of entering the outlet pipeline; and
an oxygen supply device which delivers oxygen to the inner bottom of the cultivation tank.

2. The circulating aquaculture facility for saltwater ponds according to claim 1, wherein the water inlet pipeline comprises a rectangular water inlet pipe, a circular water inlet pipe, and a rectangular box; the rectangular water inlet pipe is L-shaped, with one end being connected to the left rectangular through hole on the left wall of the cultivation tank, and the other to a bottom wall of the rectangular box; a through hole is provided on the bottom wall of the rectangular box to in connection with the rectangular water inlet pipe; a water inlet end of the circular water inlet pipe is connected to a water inlet pump; the circulate water inlet pipe allows the water to be delivered to the rectangular box.

3. The circulating aquaculture facility for saltwater ponds according to claim 2, wherein an upper end surface of the rectangular box is evenly provided with a plurality of water inlet through holes along a length direction of the upper end surface of the rectangular box; each water inlet through hole is connected to a water distribution pipe, and each water distribution pipe is connected to a circular water inlet pipe.

4. The circulating aquaculture facility for saltwater ponds according to claim 1, wherein the water outlet pipeline comprises a rectangular water outlet pipe and a circular water outlet pipe, with one end of the rectangular water outlet pipe being connected to the right rectangular through hole on the right wall of the cultivation tank, and the other to the circular water outlet pipe; the circular water outlet pipe is connected to a water outlet pump.

5. The circulating aquaculture facility for saltwater ponds according to claim 4, wherein an upper wall of the rectangular water outlet pipe is evenly provided with a plurality of air pipe joints along a length direction of the upper wall of the rectangular water outlet pipe; each air pipe joint is connected to a recoil air pipe; a first one-way valve is arranged between the recoil air pipe and the air pipe joint; each recoil air pipe is connected to a pressure source.

6. The circulating aquaculture facility for saltwater ponds according to claim 5, wherein a right end of the right inner chamber of the cultivation tank is vertically provided with a baffle; the baffle is vertically arranged and the length direction of the baffle is along a direction from front to rear of the cultivation tank; an upper end of the baffle is provided with a connecting rod; the connecting rod is vertically arranged; an upper right end of the cultivation tank is provided with a mounting frame; the mounting frame is provided with a driving cylinder; a lower end of a piston rod of the diving cylinder is connected to an upper end of the connecting rod.

7. The circulating aquaculture facility for saltwater ponds according to claim 6, wherein the upper end of the baffle is provided with a guide rod on each of the front and rear sides of the connecting rod; the guide rod is arranged vertically, and an inner wall of the right wall of the cultivation tank is provided with two guide plates; each guide plate is provided with a guide through hole, and the two guide rods respectively pass through the guide through hole of the guide plate.

8. The circulating aquaculture facility for saltwater ponds according to claim 7, wherein the oxygen supply device comprises an oxygen generator and an oxygen delivery pipe; one end of the oxygen delivery pipe is connected to an oxygen outlet of the oxygen generator, and the other end is connected to a circular water inlet pipe; the oxygen delivery pipe is provided with an oxygen delivery valve.

9. The circulating aquaculture facility for saltwater ponds according to claim 7, wherein the oxygen supply device comprises an oxygen generator and an oxygen delivery pipeline; the oxygen delivery pipeline comprises a vertical pipe, a transverse pipe and a plurality of connecting short pipes; a length direction of the transverse pipe is defined from left to right of the cultivation tank; both ends of the transverse pipe are sealed; the plurality of connecting short pipes are provided between the transverse pipe and a front wall or rear wall of the cultivation tank for connecting the transverse pipe and the front wall or rear wall of the cultivation tank; each connecting short pipe is uniformly arranged along a direction of the horizontal pipe; a second one-way valve is arranged on each of the connecting short pipes; a lower end of the vertical pipe is connected to an upper wall of the transverse pipe; an upper end of the vertical pipe is connected to the oxygen outlet of the oxygen generator.

10. The circulating aquaculture facility for saltwater ponds according to claim 9, wherein two oxygen delivery pipelines are provided; the two oxygen delivery pipelines are respectively arranged on the front a rear sides of the cultivation tank; the two transverse pipes of the two oxygen delivery pipelines are respectively located at the front side of the cultivation tank and the rear side of the cultivation tank; the horizontal pipe located on the front side of the cultivation tank is connected to the lower end of the front wall of the cultivation tank through the plurality of connecting short pipes; the transverse pipe located on the rear side of the cultivation tank is connected to the lower end of the rear wall of the cultivation tank through the plurality of connecting short pipes.
